(19) United States
(12) Patent Application Publication
(10) Pub. No.: US 2012/0209697 A1
(43) Pub. Date: Aug. 16, 2012

(54) Bias Reduction in Internet Measurement of Ad Noting and Recognition

(76) Inventors: Joe Agresti, Yorktown Heights, NY (US); Konstantin Augemberg, New York, NY (US); Julian Baim, Montville, NJ (US); Marty Frankel, Cos Cob, CT (US); Mickey Galin, New York, NY (US)

(21) Appl. No.: 13/271,956

(22) Filed: Oct. 12, 2011

Related U.S. Application Data
(60) Provisional application No. 61/393,125, filed on Oct. 14, 2010.

(51) Int. Cl. G06Q 30/02

(52) U.S. Cl. 705/14.45

(57) ABSTRACT

A model-based method for reducing selection bias in Internet samples utilizes a series of sample weighting procedures that adjust the distribution of key drivers of ad noting and recognition in Internet samples to mirror the distribution of the drivers found in a full-probability sample. In the first phase of the method, a relatively large number of Starch studies are utilized to explore and understand key drivers of ad noting and recognition using multivariate regression analysis. The second phase compares the distribution of the key drivers found in Internet samples with the distribution of those drivers obtained in a full-probability sample to develop the weighting adjustment. In the third phase, the impact of the weighting adjustment is evaluated using a mean squared error model.

### STATEMENT OF RELATED APPLICATION

This application claims the benefit of provisional application No. 61/393,125, filed Oct. 14, 2010, which is incorporated by reference herein.

### BACKGROUND

The visual capabilities offered by the Internet provide a platform by which magazine readers may be queried about their viewing, noting, and recognizing of ad copy appearing in specific magazine issues. However, it is well known that “samples” used in these studies may be subject to substantial bias arising from the non-probability nature of the sample selection process. Furthermore, when correctly computed, the response rates on many Internet panels are quite low. Accordingly, methods to reduce selection bias would be desirable in order to improve the effectiveness in observing and measuring ad noting and recognition.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A model-based method for reducing selection bias in Internet samples utilizes a series of sample weighting procedures that adjust the distribution of key drivers of ad noting and recognition in Internet samples to mirror the distribution of the drivers found in a full-probability sample. The model-based method is developed, implemented, and evaluated in three phases. In the first phase, a relatively large number of Starch studies are utilized to explore and understand key drivers of ad noting and recognition using multivariate regression analysis. The second phase compares the distribution of the key drivers found in Internet samples with the distribution of those drivers obtained in a full-probability sample to develop the weighting adjustment. In the third phase, the impact of the weighting adjustment is evaluated using a mean squared error model. When applied to actual data, application of the method provides substantial evidence that weighted ad noting and recognition estimates are subject to less sample selection bias compared with those estimates derived without adjustment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 is a flowchart showing an overview of an illustrative implementation of the present model-based method for reducing bias in Internet samples;

FIGS. 2-4 show sub-steps of various phases in the model-based method;

FIGS. 5, 5A, 5B, and 5C show a table containing illustrative coefficients;

FIG. 6 shows a table of illustrative coefficients for regression;

FIGS. 7, 7A, 7B, and 7C show a table of illustrative weighting variables and magazines;

FIG. 8 shows a table illustrating the impact of composition targeting on ad noting score average by magazine publication frequency; and

FIG. 9 shows a table illustrating the impact of composition targeting on ad noting score average by magazine genre.

### DETAILED DESCRIPTION

In accordance with the principles of the present method, it is recognized that when certain key variables are statistically linked (i.e. strongly correlated) with sample selection bias and key substantive outcomes, these key variables may be used to adjust or calibrate ad noting and recognition estimates. Such adjustment/calibration is typically referred to as post stratification in traditional full-probability sampling and model-based estimation for model-based (i.e., non-probability) sampling. In examining a large number of Internet samples used to collect data on ad noting and ad recognition it has been found that these outcome measures are associated and correlated, to varying degrees, with gender, time spent reading, place of reading, percent of pages opened, and frequency of reading. Furthermore, the distribution of these variables among Internet respondents has been found to be substantially different from those in traditional full-probability surveys.

In view of this recognition, the present bias reduction method applies a series of estimations using sample weighting to remove a substantial amount of selection bias linked to these reading qualities. It has been determined that the application of bias reduction results in meaningful changes in readership ad noting and recognition. When applying these weights, a standard minimization of mean squared error approach and perspective is adopted. That is, any weighting which increases variable random error will be offset with bias reduction. Bias reduction occurs when changes in the survey estimates are observed. Within a single magazine issue, the overall changes in ad noting scores are not typically large. However, there are ads in which noting scores do show substantial change. These changes are consistent with expectations linked to the adjustment measures.

The present model-based bias reduction method utilizes Starch ad readership studies (i.e., AdMeasure studies) currently available from MRI Starch. “Starch Scores” for print advertising have been part of the advertising vocabulary since the 1920s (see, e.g., William Leiss, Stephen Kline et. al., “Social Communication in Advertising,” Richard W. Pollay, ed. Information Sources in Advertising History, Westport, Conn., Greenwood Press, 1979). When first introduced, Starch Scores were obtained from an in-person sample of individuals who were asked to indicate if a print ad had been noted and associated with a particular (i.e. the actual) ad sponsor. More recently, the Starch methodology has been adapted for use on the Internet. Since Internet-based surveys are not generally based on probability samples of the full population, but rather samples of individuals who have “opted in” or agreed to be part of a sample panel, an important question is that of sample validity. Specifically, is there confidence that the results of these samples are consistent with the results that would be obtained from a full population-based probability sample? A review of the literature indicates that in-person Starch administration was based on the quota sampling that was in common use for marketing research in the early 1940s (see, e.g., T. Mills Shepard, “The Starch Application of the Recognition Technique,” The Journal of Marketing, Vol. 6, No. 4, Part 2 (April, 1942), pp. 118-124).

One possible approach to assessing the comparability of an Internet-based administration with a door-to-door full-probability sample question, would involve pairing the current methodology with a large scale door-to-door full-probability study. While this approach is theoretically correct, the development of this study would not only be cost prohibitive but, most likely, operationally impossible.

As a more feasible approach to this comparison, examination of the statistical behavior of the basic Starch measures may be undertaken with the goal of understanding the basic reading behavior covariates that appear to drive (or at least vary with) ad noting and recognition. On the basis of this examination it is determined that without adjustment, basic Starch levels are not consistent with those that would be obtained from a door-to-door full-probability sample. Furthermore, such analyses suggest that estimates obtained in door-to-door administrations might also suffer from some bias due to the timing of the interview relative to the publication date (i.e., estimation bias might increase as the length of time increases between the interview and the subject's exposure to a particular ad). The results of such analyses suggest a weighting process that adjusts the sample of data collected from our Internet administration to more closely conform to the corresponding sample that would be obtained from strict probability samples implemented under ideal conditions. The development of these weights is based on examination of the sample characteristics that are drivers of ad noting and recognition.

From the standpoint of statistical and sampling theory, the approach outlined above falls under the heading of model-based (i.e., “assisted”) sampling and estimation. The translation of this statistical theory into a sampling and estimation approach involves the selection of a sample from two different Internet sample panels based on the reporting of prior reading in the appropriate magazine category. It also involves the use of a full-probability national readership survey and an “issue-specific” survey to develop respondent level estimation weights that reduce the sample selection bias of the basic Starch Internet sample. Such surveys are performed by GfK Mediamark Research & Intelligence, LLC (“GfK MRI”). While use of this model-based adjustment weighting is not likely to fully account for the lack of full-probability randomization, such statistical methods can be expected to reduce both sample selection and sample estimation bias with satisfactory results in many applications.

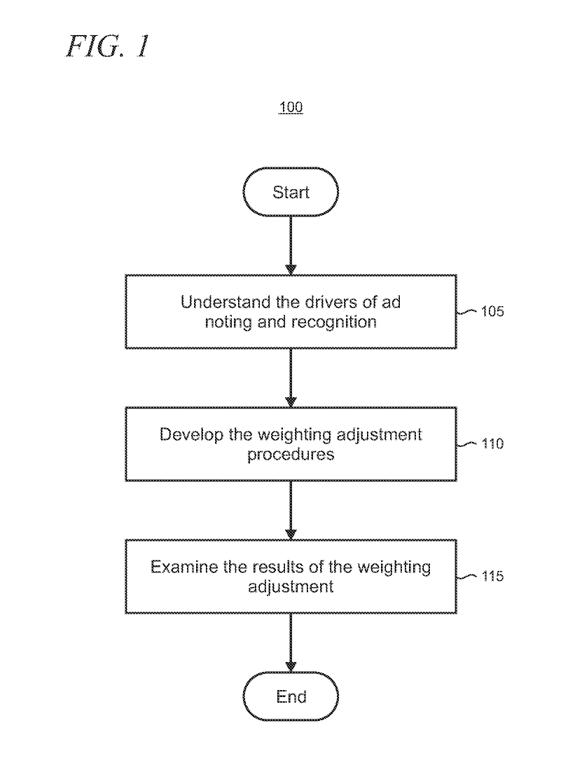

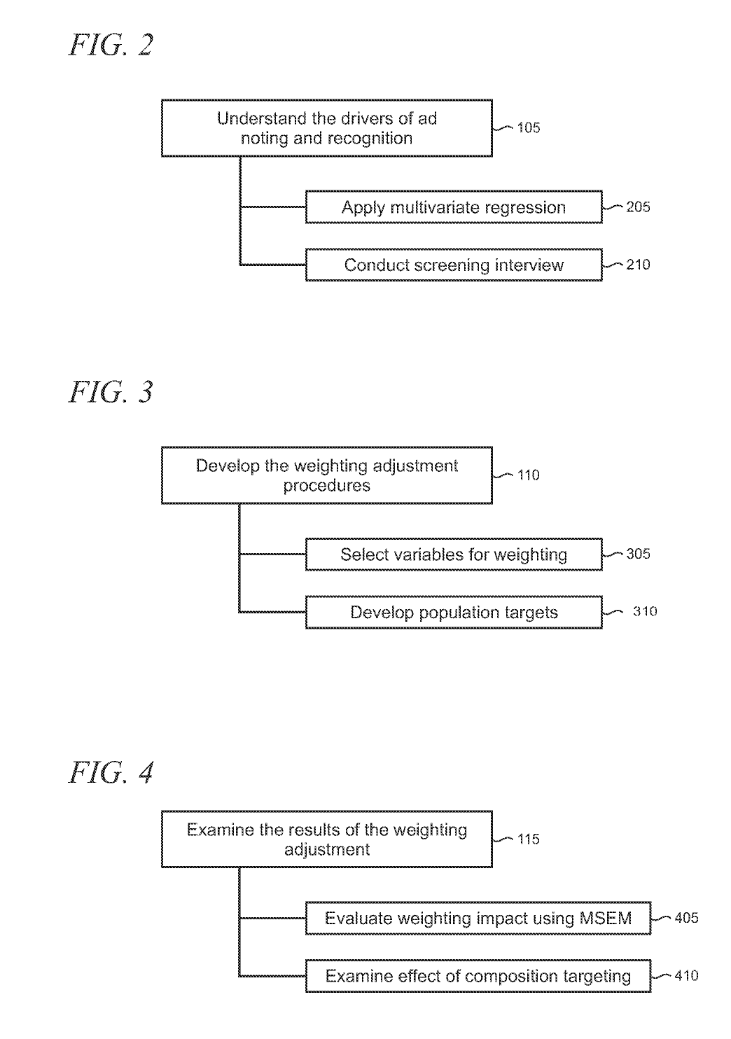

Turning to the drawings, FIG. 1 is a flowchart showing an overview of an illustrative implementation of the present model-based method for reducing bias in estimates of ad noting and recognition in Internet samples. The model-based method 100 is developed, implemented, and evaluated in three phases including understanding the drivers of ad noting and recognition, developing the weighting adjustment procedures, and examining the results of the weighting adjustment, as respectively indicated by reference numerals 105, 110, and 115. Each phase will typically include several sub-steps as shown in FIGS. 2-4 and described below.

In the first phase 105 of the model-based method, a relatively large number of Starch studies may be utilized to explore and understand some of the key drivers of ad noting and recognition. This phase utilizes multivariate regression (GLM-OLS; Generalized Linear Model—Ordinary Least Squares) with a data set, for example, of more than n=30,000 ads in multiple issues of 100 magazines as indicated by reference numeral 205 in FIG. 2. It is observed that the basic rationale for Starch studies is the belief that not all advertisements in a given magazine have the same impact on all readers. In translating this observation into actual survey measurements, the Starch approach has focused on three basic steps: ad noting, ad recognition and actions taken.

In order to understand some of the ways in which Internet samples and in-person samples might produce different Starch measures, focus is placed on readership characteristics associated with the first basic step in this measurement process, that of ad noting. It should be understood that a basic assumption is that the single most important driver of ad noting is the creative content of the ad itself. This includes both the topic and how it is presented on a web page (in terms of pictures, text, and layout). However, based on general beliefs among individuals involved in the print media and based on respondent reports about how they read both magazine editorial and ads, it is also assumed (subject to present analyses) that there would be a number of secondary factors (in addition to the creative content) influencing and associated with ad noting and subsequent ad recognition. With this observation in mind, the variation in the propensity to note ads among more than 30,000 respondents in approximately 100 recently conducted Starch studies is examined. This examination makes use of OLS regression analysis in which the outcome variable is the probability of ad noting and the predictor variables are basic respondent demographics, reported readership behavior, and the individual magazine titles.

The basic regression model is of the form

Y=β₀+β₁X₁+β₂X₂+β₃X₃+ . . . βₖXₖ+ε

where Y is the outcome measure, “propensity to note an ad”, and X₁, X₂, X₃ . . . Xₖ are the predictor variables (demographics, reading behaviors, and magazine titles).

The respondents used in this particular analysis were those who participated in one of approximately 100 Starch studies conducted over the Internet. The respondents for these studies are selected from among those opt-in Internet panel members who indicated that they generally read or subscribe to certain

For a particular study of the ads in a specific magazine issue, panel members who indicated that they are readers of the magazine are sent an email invitation to take a screening interview, as indicated by reference numeral 210 in FIG. 2. This screening interview is used to determine if the respondent read the particular issue that is being studied.

Those who qualify as readers are shown a series of 25 ads that appeared in the issue and are asked if they remember seeing the ad and associating it with a particular (correct) advertiser. Those who give a positive first response are counted as “noting the ad.” Those that give two positive responses are counted as “associated the ad.” Since most magazines carry more than 25 ads, separate qualifying samples of individuals are used for each group of up to 25 ads. The typical Starch study uses a sample size of 125 respondents for each group of ads.

For the regression analysis, an average noting score can be calculated for each respondent by dividing the number of ads noted by the number of ads shown to the respondent. This score may be viewed as a probability or propensity that the respondent noted an ad in the particular issue of the magazine. This score has a range of 0.0 (no ads noted) to 1.0 (all ads noted). This is the outcome measure Y.

The potential predictor variables to be examined and assessed in the regression consist of basic demographics, readership characteristics and behaviors, as well as the individual magazines titles. The demographic variables reflect the demographic characteristics of the respondent. These characteristics may be, for example, gender, age, education level, income, marital status, race, Hispanic origin, and employment status.

The readership characteristics reflect the respondents' reported behavior with respect to frequency of reading that particular magazine title (1, 2, 3, and 4 of 4 issues on average), time spent reading that issue (under 30 minutes, 30-60 minutes, more than 60 minutes), how many of the pages were opened (from just skimmed, to the entire issue), the source of copy (subscriber, newsstand, other), where read (in home, out of home), and how long the respondent has been a reader of the magazine.

Each of the different magazine titles is used in the equation. In the case of magazine titles, these variables are expressed as dummy variables. For example, the dummy variable “people” is set to 1 for respondents who were asked about People Magazine and it is set to 0 for respondents who were asked about some other magazine. As is standard practice only 58, rather than 59 magazine variables are created to avoid the singularity condition.

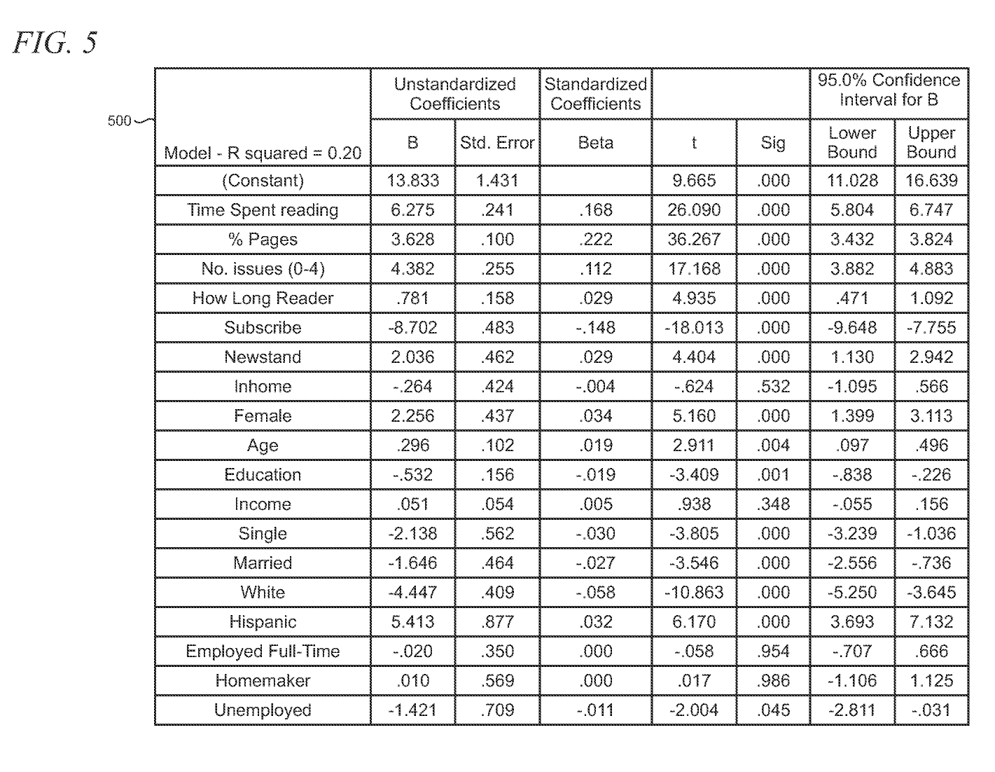

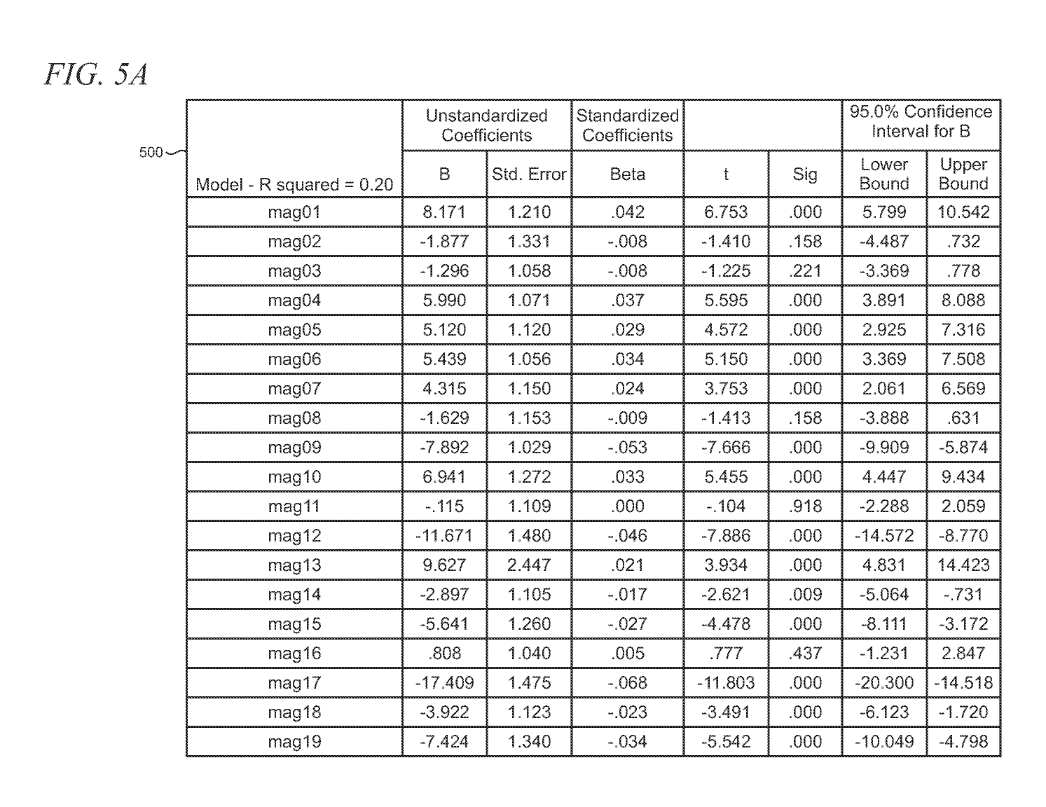

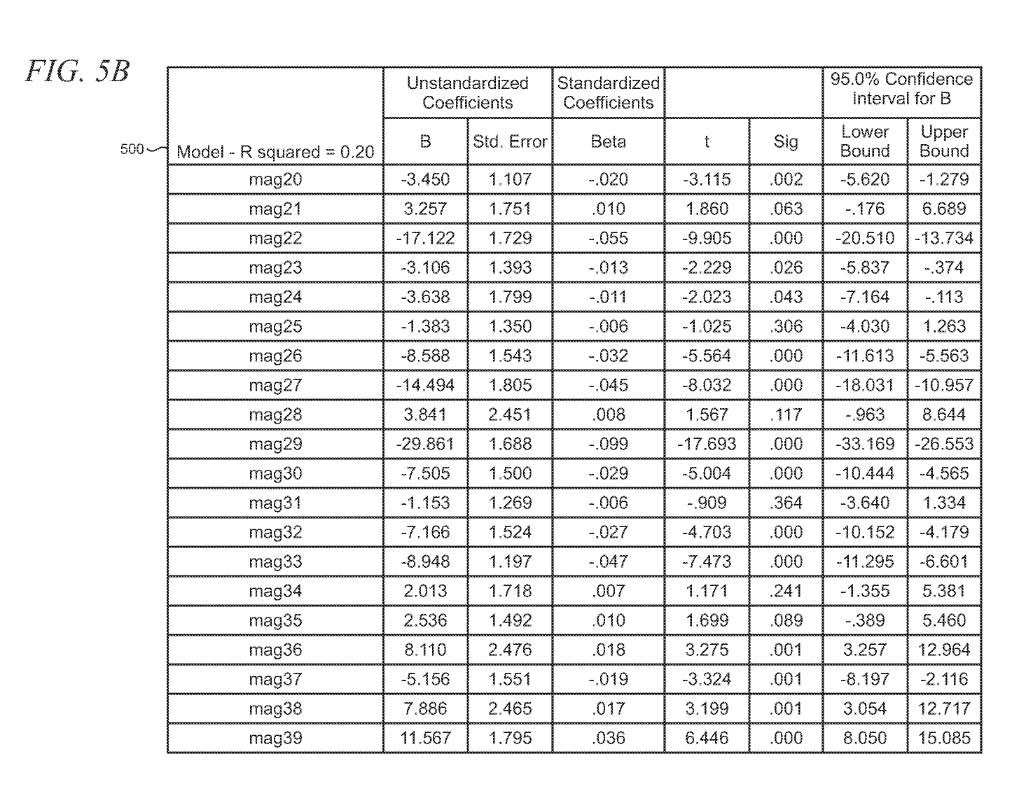

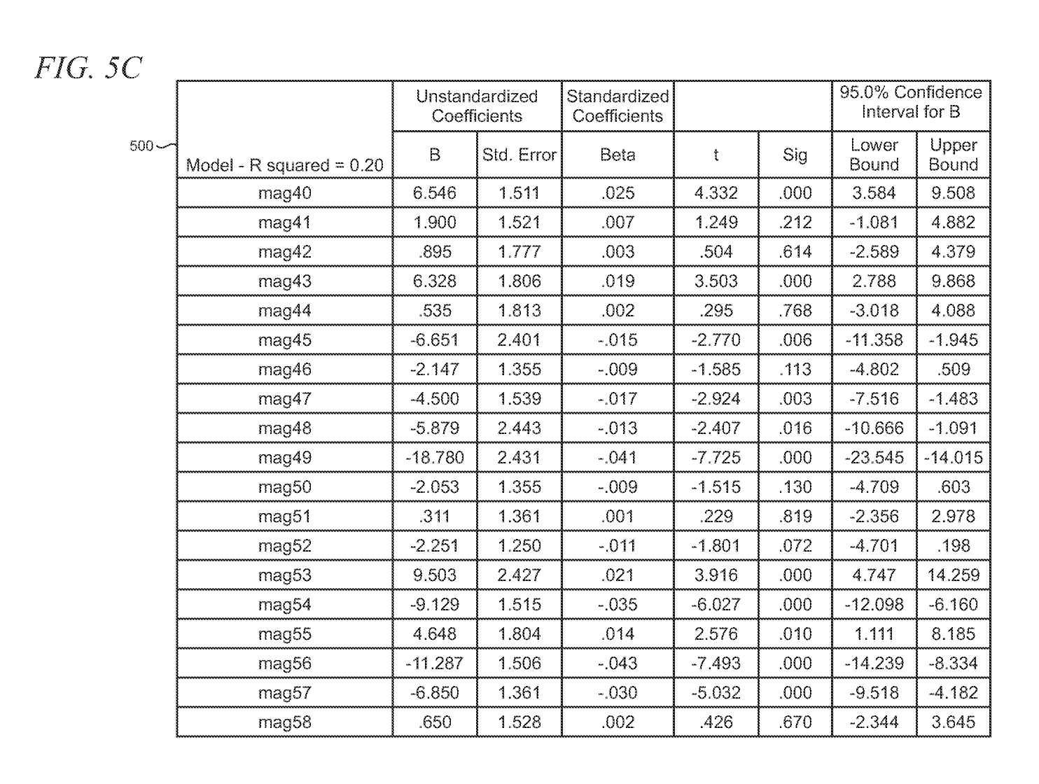

The overall regression model involves 75 variables and is based on a sample of 30,555 respondents. The regressions are run using all variables and also using a stepwise regression procedure. The coefficients resulting from this regression are shown in the table 500 spanning FIGS. 5, 5A, 5B, and 5C. For sake of clarity in exposition, only the results of the full regressions are shown. In general however, because of the large sample sizes the results of the full and stepwise regressions are almost identical.

For the full set of variables, both full and stepwise regressions produce a multiple R-squared (adjusted) of 0.20 or 20%. This is an important result since it indicates that a large portion of the variation in ad noting is the result of factors other than demographics, reading behavior, and magazine context. It is assumed that a substantial portion of variation is due to the ads themselves.

However, it is also noted that about 20% of the variation is due to factors that might be called “non-ad-creative” drivers. This suggests that differences between the sample and population with respect to these “non-ad-creative” drivers will probably produce bias in the sample estimates (It is noted that the term “bias” is used herein in its standard statistical context. For a particular estimator f of population parameter F, the bias off is defined as Bias(f)=E(f)−F, where E(f) is the sample expectation over the full sampling distribution). However, some of this bias may be reduced by appropriate sample weighting by making the sample more closely resemble the population with respect to these particular drivers.

For example, the analysis in the first phase of the present method can show that drivers such as time spent reading, percentage of pages opened, number of issues out of four read and gender, are key “drivers” of ad noting. If it is found that the representation of these factors in the sample is not in line with that of the full population this means that the estimates will probably be “biased.” If the sample distribution of some of these drivers is corrected, then some of this bias may be eliminated.

Once the non-ad-creative drivers of ad noting are identified, the next phase 110 in the model-based method 100 in FIG. 1 may be started. This phase consists of first determining if the Internet samples are properly representative of these key driver distributions and, if not, selecting variables for weighting and developing corrective weights, as indicated by reference numeral 305 in FIG. 3.

It is observed that the demographic composition of Internet samples is generally not the same as found in well-executed full-probability surveys of the full population. In addition, the demographic composition of sample subsets of readers of specific magazines, does not typically agree with those compositions found in full-probability samples. In some cases, Internet surveys may be somewhat skewed with respect to non-demographic readership characteristics-specific magazines as well. With this in mind, the distribution of readership characteristics may be examined, on a magazine-by-magazine basis, among readers in the GfK MRI full-probability survey “The Survey of the American Consumer” and those found among Starch respondents. In general, it may be found that when compared to full-probability samples, the Internet tends to produce samples of readers who are more likely to be in-home readers, more frequent readers, and readers who look into more of the magazine. Furthermore, readers in Internet samples tend to spend more time reading than those found in full-probability samples. Additionally, depending upon the genre of the magazine, the gender distribution in Internet samples tends to favor the dominant gender relative to what is found in full-probability samples. Finally, it is observed that there are sample composition differences (Internet versus full-probability) with respect to reader's education, employment, marital status, and to some degree race/ethnicity.

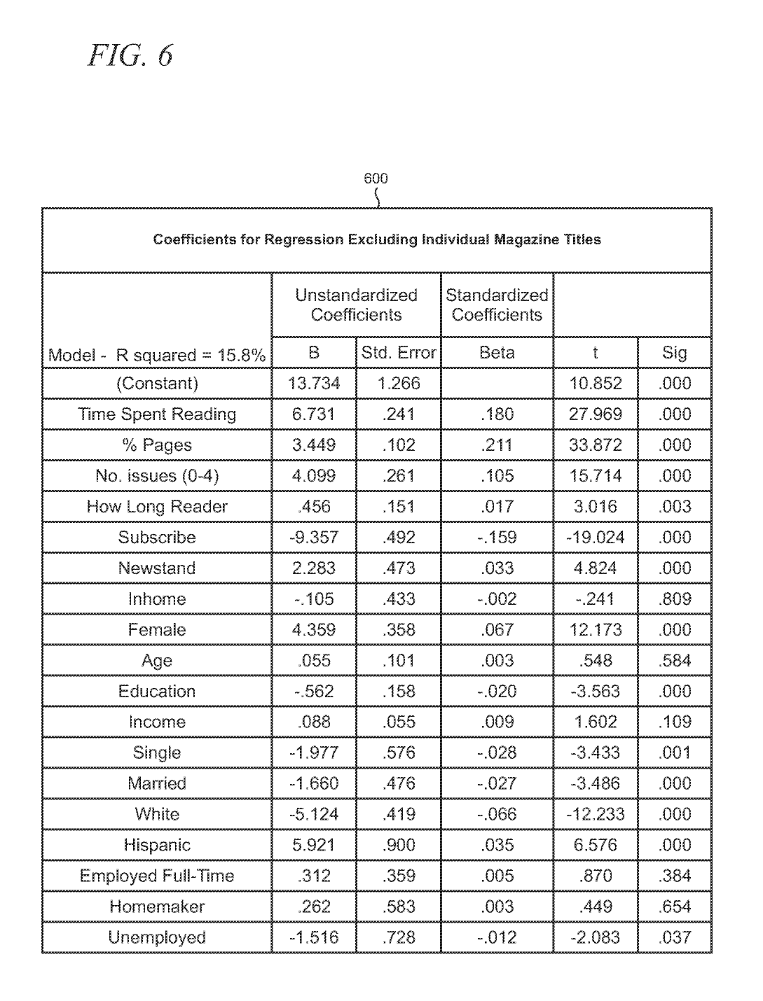

Once the fact is established that Internet samples produce distributions of magazine readers that are different from those found in full-probability samples, the next objective is to focus on those differences that are important to ad noting. In carrying out this process under “ideal conditions” variables are first rank-ordered by a measure of their importance as drivers and then the degree to which the distribution of these drivers differs between the Internet samples and the full-probability sample standard is examined. Typically, this ordering is accomplished by examining the size of the “standardized” regression coefficients. The table 600 in FIG. 6 shows both un-standardized and standardized coefficients for all demographic and readership characteristics variables. It is noted that individual magazine titles are excluded from this analysis and the dependent variable is adscore.

As the magnitude of the standardized coefficients indicates, the order of examination in a theoretically ideal world would start with Percentage of Pages, and continue with Time Spent Reading, Subscriber Status, Number of Issues read out of four, etc. However, there are two other considerations that may be taken into account in view of real world limitations. First, while it is known that bias reduction based on sample weighting is possible, it is noted that the number of respondents in the Starch Surveys is only moderately large (approximately 125 respondents are asked about a specific ad). As a result, the number of variables to be used in weighting is limited to a maximum of three.

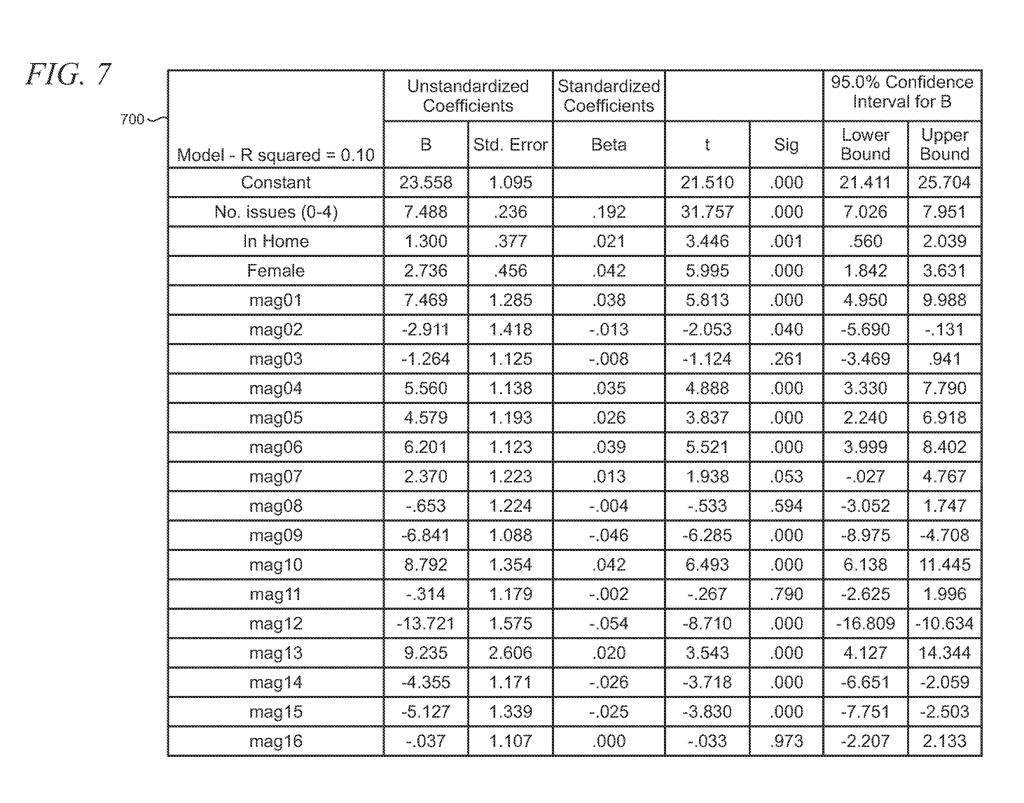

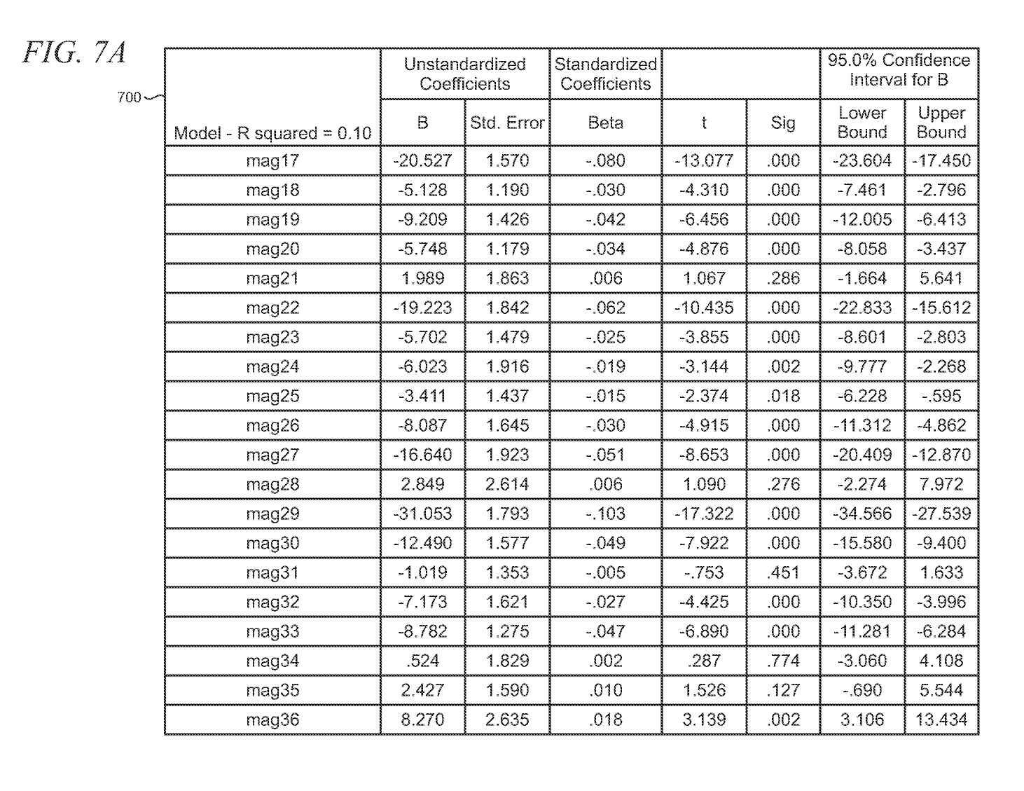

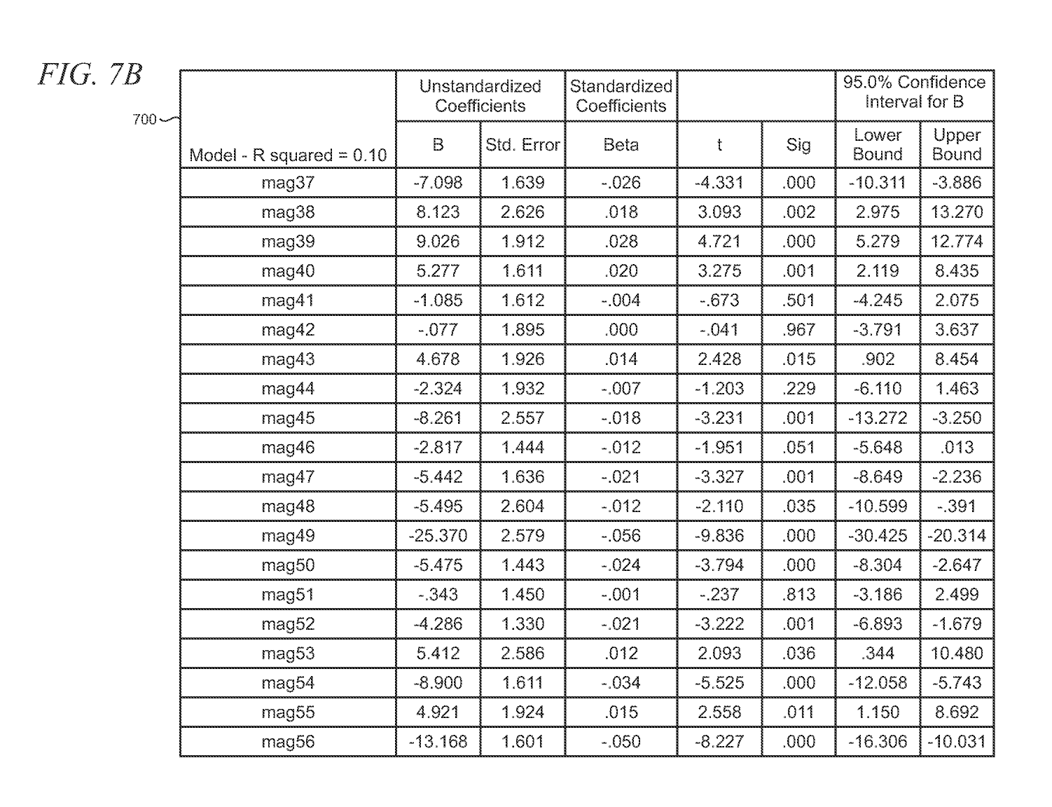

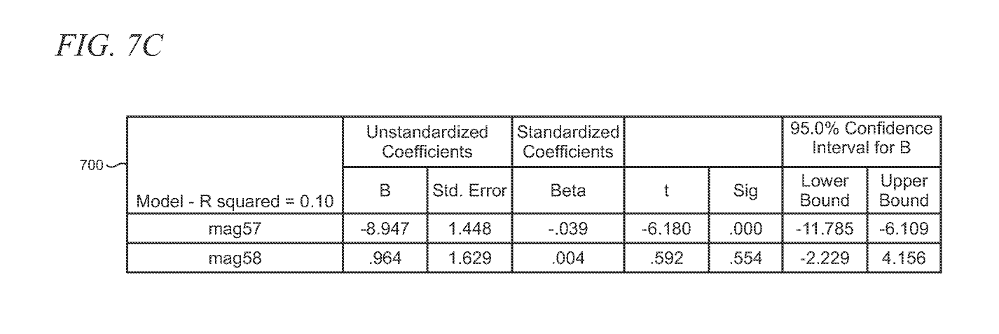

Furthermore, as a result of the development of the issue-specific magazine measure noted above, note of the fact is made that, along with variation in audience size, the specific demographic composition of a particular magazine varies from issue to issue. In addition, “readership characteristics” among readers may vary from issue to issue as well. Thus, to the extent that either a demographic or readership behavior characteristic is to be used for “weighting” the sample to agree with a more appropriate parameter, the estimate of the parameter cannot be properly based on an average issue value. Rather, the parameter estimate reflects the particular readership of the issue in which the ad appears. This requirement restricts the choice of variables to those that may be “consistently” measured in the national study, the issue-specific study, as well as the Starch study. Given these conditions, the initial choice of variables for post-adjustment weighting may be the number of issues read, place of reading, and gender. Based on a regression analysis restricted to the variables selected for weighting and individual magazines, as illustratively shown in table 700 spanning FIGS. 7, 7A, 7B, and 7C, an R-squared value of 10.0% indicates that approximately 50% (final variable and magazine R-squared 0.10 full variable and magazine R-squared 0.20) of the potential “bias reduction” is captured that is available through weighting. Furthermore, the three basic weighting variables show a statistically significant impact on ad noting.

While the basic analysis compares the distribution of readers found in the national probability-based Survey of the American Consumer with those obtained on the Internet, it is recognized that these average distributions might, in fact, change from issue to issue. Ample evidence of this may be obtained from the issue-specific study, noted above, where large issue-to-issue differences in the gender distribution are both observed and make a great deal of sense. For example, issues of the same weekly news magazine that focus on family topics seem to attract a larger proportion of female readers while those focusing on war tend to disproportionately skew toward males. The same holds with respect to reader type (i.e., readership behavior).

As noted above, rather than weighting the distribution among key drivers of noting to “averages” for the magazine, it may be more appropriate to make use of the GfK MRI issue-specific study to produce target distributions for the specific issue where ads are measured, as indicated by reference numeral 310 in FIG. 3. The methodology for using the issue-specific study is similar to that used to derive issue-specific audiences.

Specifically, the issue-specific study relies on Internet samples and an estimation algorithm for deriving issue-specific audiences does not use the “absolute” readership levels but rather the issue-to-issue differences in these readership levels. The same general method is applied in order to derive the required “issue-specific” weighting parameters. In recognition of the fact that the weighting parameters of gender, number of issues read, and place of reading refer to the specific issue that was used in the Starch study, the term “Composition Targeting” has been adopted to describe this issue-specific process.

One of the standard outputs of the issue-specific study is the issue-specific gender distribution. Thus the gender distribution is available for the composition targeting weighting system without further processing. Development of the frequency of reading distribution (i.e., number of issues out of four) as well as place of reading distribution make use of an estimation process similar to that used to develop issue-specific age and gender distributions. Specifically, the distributions of frequency of reading among readers and place of reading from the Survey of the American Consumer are adjusted based on the relative changes from issue to issue found in the issue-specific study. If a particular issue of a magazine tends to attract less frequent readers, as it often does with a larger than average audience, this is reflected in target distribution for frequency of reading.

It should be noted that the development of these issue-specific targets and the application of these targets in the weighting involves time bound processing intervals, since final results are typically delivered 6-8 weeks after the publication date of a weekly magazine.

The next phase 115 in the present model-based method 100 in FIG. 1 is the examination of the results of the weighting adjustment. The goal in the application of weights to the Internet-based Starch sample data is the reduction of bias. Using a Mean Squared Error Model (MSEM) for the evaluation of the impact of weighting, as indicated by reference numeral 405 in FIG. 4, it can be expected that a weighting process that reduces bias will result in changes in the estimates produced (where the MSEM evaluates the random error portion and the bias portion of an estimate. The mean squared error is equal to the variance of the estimate (standard error squared) plus the squared bias. Given a weighting model, the difference between the unweighted and weighted estimate provides an estimate of the bias term). That is, the survey estimates produced by a weighting that reduces bias will be different from those estimates obtained without weighting. Since the application of weights increases the “random error” associated with an estimate, if there is no change in the estimate itself, then the increased error due to weighting cannot be justified. In examining the overall impact in ad noting scores over 194 Starch Studies (magazine issues) covering more than 40,000 ads, it is found that the average unadjusted ad noting score is 50.45% and the average weighted (composition targeted) ad noting score is 48.83%.

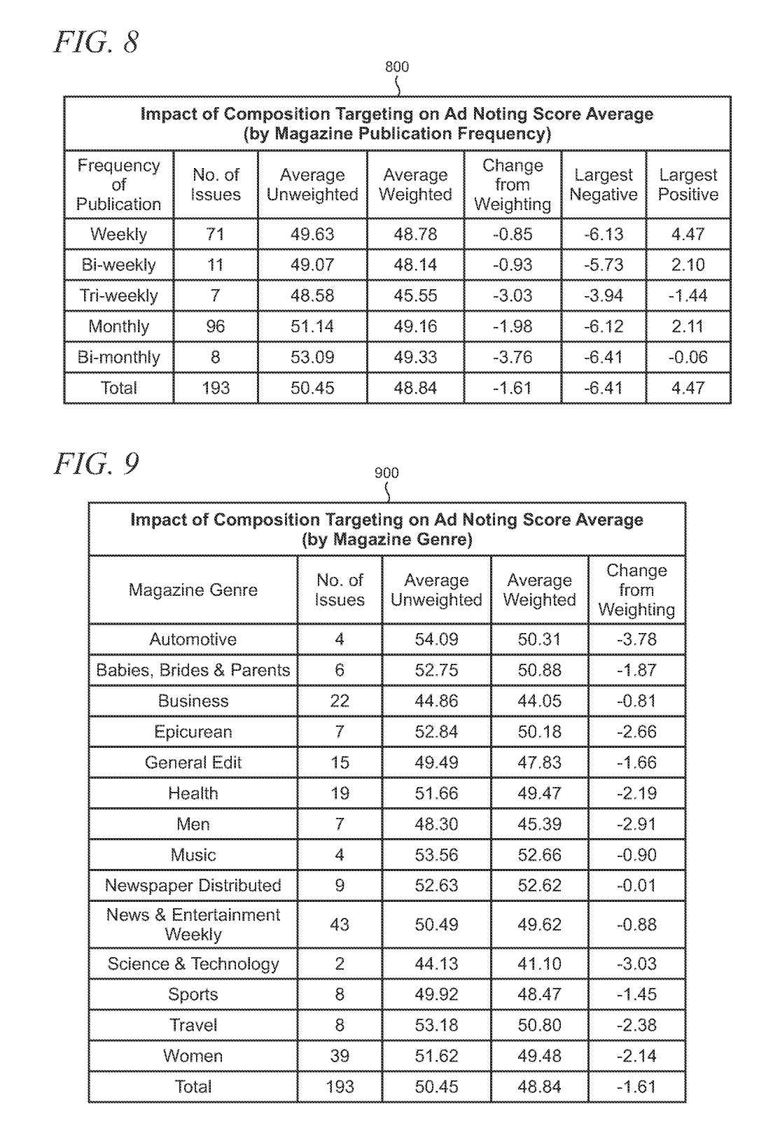

This change in ad noting scores is not large on average, but changes in individual scores may be more substantial (upward of 10% in either direction and occasionally greater than 15% in either direction). The direction of the change between adjusted and unadjusted ad scores is entirely consistent with reasonable expectations since it may be observed that Internet-based samples tend to over-represent both in-home and more frequent readers and these two groups tend to produce higher ad noting scores. By correctly down-weighting these sample groups, a decline in ad noting is entirely consistent with reasonable expectations. The effects of composition targeting may also be examined (i.e., issue-specific impacts), as indicated by reference numeral 410 in FIG. 4. For example, it has been found that the magnitude of the overall magazine adjustment level for ad noting scores varies by publication interval. The table 800 in FIG. 8 illustratively shows the average unadjusted and adjusted ad noting scores by publication interval. Also shown are the minimum and maximum average changes in score, by magazine, associated with composition targeting weighting.

The degree of adjustment by magazine genre may also be examined as shown by the illustrative data in the table 900 in FIG. 9. In this case, while there is some independent impact of genre, much of the differences are driven by frequency of publication. This can be seen in the fact that for Newspaper Distributed magazines there is virtually no change and in News and Entertainment Weeklies the overall change is minimal. Within these titles, it is found that changes in particular ad scores may be the result of bias correction with respect to gender and frequency of reading. Ads which differentially appeal to more frequent and /on-gender readers show declines, while those ads that appeal to less frequent and off-gender readers show increases.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for reducing bias in Internet measurement of ad noting, the method comprising the steps of:
identifying key drivers of ad noting by analyzing data from a non-probability Internet sample;
developing weighting for application to variables in the Internet sample by comparing a distribution of the identified key drivers in the Internet sample to a distribution of the key drivers in a full-probability sample; and
applying a weighting adjustment to the Internet sample by adjusting the distribution of identified key drivers in the Internet sample to match the distribution of identified key drivers in the full-probability sample.

2. The method of claim 1 further including a step of evaluating results of application of the weighting adjustment using a mean squared error model.

3. The method of claim 1 further including a step of examining results of composition targeting, the composition targeting being utilized to develop issue-specific weighting parameters.

4. The method of claim 3 in which the composition targeting relies on data from one or more issue-specific studies.

5. The method of claim 3 further including the steps of examining effects of composition targeting by magazine publication frequency and examining effects of composition targeting by magazine genre.

6. The method of claim 1 in which the non-probability Internet sample comprises one or more Starch studies.

7. The method of claim 1 in which the analyzing comprises utilizing multivariate regression to the data, the data comprising ads in a plurality of magazines.

8. The method of claim 1 in which the key drivers comprise non-ad-creative drivers.

9. The method of claim 1 in which the key drivers comprise one of time spent reading, percentage of pages opened, number of issues read out of four, or gender.

10. The method of claim 1 including a further step of selecting variables for weighting by rank-ordering variables according to regression coefficient size.

11. The method of claim 10 in which the selected variables comprise at least one of gender, number of issues read, or place of reading.

12. The method of claim 1 in which the identifying includes conducting one or more screening interviews of Internet survey participants.

13. A method for reducing bias in Internet measurement of ad noting, the method comprising the steps of:
deriving model-based weights by comparing a distribution of non-ad-creative drivers in non-probability Internet samples with a distribution of non-ad-creative drivers in full-probability samples, the non-ad-creative drivers including at least one of gender, number of issues read, or place of reading;
applying the model-based weights by adjusting the distribution of non-ad-creative drivers in the non-probability Internet samples to substantially match the distribution of non-ad-creative drivers in the full-probability samples; and
observing changes in Internet survey estimates of ad noting after the application of the model-based weights to determine occurrences of bias reduction.

14. The method of claim 13 further including a step of selecting the non-ad-creative drivers in the distributions by applying multivariate regression to a plurality of Starch Internet samples.

15. The method of claim 14 in which the multivariate regression is performed full or stepwise.

16. The method of claim 13 further including a step of utilizing a full-probability national readership survey to determine readership characteristics.

17. The method of claim 13 further including a step of utilizing an issue-specific study to produce target distributions of readers for specific issues in which ads are measured.

18. The method of claim 17 in which the application of the target distributions involve time bound processing intervals.

19. The method of claim 13 in which at least a portion of the method is performed in an automated manner by executing instructions stored on one or more non-transitory computer-readable storage media.

20. The method of claim 13 in which the observing is facilitated by application of a mean squared error model.
